(19) United States
(12) Patent Application Publication
(10) Pub. No.: US 2011/0086140 A1
(43) Pub. Date: Apr. 14, 2011

(54) Food Product Pertaining to a Filling-and-Cracker Sandwich

(75) Inventors: James A. Schulok, Garnerville, NY (US); Karen Freyre, Closter, NY (US); Priyank Tulsiyan, Parsippany, NJ (US)

(73) Assignee: Kraft Foods Global Brands LLC, Northfield, IL (US)

(21) Appl. No.: 12/576,876

(22) Filed: Oct. 9, 2009

(51) Int. Cl. A23C 19/09; A21D 13/00; A23L 1/10

(52) U.S. Cl. 426/90; 426/94

(57) ABSTRACT

A single serving of a food product can comprise a first cracker, a second cracker, and a non-cracker filling disposed between these crackers to form a cracker-and-filling sandwich. By one approach, these crackers have a length of at least three inches. By one approach, the cracker-and-filling sandwich is sized and comprised of ingredients such that eating the cracker-and-filling sandwich as a between-meal snack satisfactorily sates an average adult human being's appetite. By one approach, the aforementioned filling has an adhesive characteristic sufficient to retain these crackers in place during pre-sale handling, distribution, and sale of the food product, but wherein the adhesive characteristic is not sufficient to prevent an end user from easily removing, by use of their hands only, one of the crackers from the filling without breaking either of the crackers and without requiring that the cracker being removed be rotated with respect to the filling.

### RELATED APPLICATION(S)

This application is related to co-pending and co-owned U.S. patent application Ser. No. 29/345,136 (attorney's docket number 1410/96972), entitled Food Product and filed on even date herewith, which is incorporated by reference in its entirety herein.

### TECHNICAL FIELD

This invention relates generally to food products and more particularly to pre-packaged snack items.

### BACKGROUND

Food products of various kinds are known in the art. This includes an entire genre of items popularly referred to as snack items. Snack items are food products that are typically intended and designed for consumption between normally-scheduled meals (these being breakfast, lunch, and dinner, respectively). Generally speaking, and as used herein, a “snack” is something that is intended to assuage a person's hunger pending that next normally-scheduled meal. The degree to which a given food product succeeds in this regard is a measure of that food product's satiety.

Crackers of various kinds are often treated, alone or in combination with other ingredients, as a snack. Cheese or cheese-like fillings are often used in combination with two crackers that form a small corresponding sandwich. A packaged offering in these regards will typically include a plurality of such sandwiches. The total contents of such a packaged offering may comprise, in the aggregate, an intended single serving as a snack or may contain multiple servings.

Packaged snack foods are highly popular in many cultures. Confusion can arise on the part of the consumer, however, regarding appropriate snack portions and serving sizes. This confusion can lead to both under and over-consumption. Under-consumption can, in turn, lead to re-experienced hunger prior the next naturally-scheduled meal while over-consumption has its own associated plethora of unwanted consequences.

### BRIEF DESCRIPTION OF THE DRAWINGS

The above needs are at least partially met through provision of the a food product pertaining to a filling-and-cracker sandwich described in the following detailed description, particularly when studied in conjunction with the drawings, wherein:

FIG. 1 comprises a flow diagram as configured in accordance with various embodiments of the invention;

FIG. 2 comprises a perspective view as configured in accordance with various embodiments of the invention;

FIG. 3 comprises a top-plan detail view as configured in accordance with various embodiments of the invention;

FIG. 4 comprises a top-plan view as configured in accordance with various embodiments of the invention;

FIG. 5 comprises a perspective detail view as configured in accordance with various embodiments of the invention;

FIG. 6 comprises a perspective view as configured in accordance with various embodiments of the invention;

FIG. 7 comprises a perspective view as configured in accordance with various embodiments of the invention;

FIG. 8 comprises a perspective view as configured in accordance with various embodiments of the invention;

FIG. 9 comprises an exploded perspective view as configured in accordance with various embodiments of the invention;

FIG. 10 comprises a top-plan view as configured in accordance with various embodiments of the invention; and

FIG. 11 comprises a perspective view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a single serving of a food product can comprise a first cracker, a second cracker, and a non-cracker filling disposed between the first and second crackers to form a corresponding cracker-and-filling sandwich. By one approach, the crackers are unusually long and have a length of at least three inches. By one approach, the cracker-and-filling sandwich is sized and comprised of ingredients such that eating the cracker-and-filling sandwich as a between-meal snack satisfactorily sates an average adult human being's appetite pending a next normally-scheduled meal. By one approach, the aforementioned filling has an adhesive characteristic sufficient to retain first and second crackers in place during pre-sale handling, distribution, and sale of the food product, but wherein the adhesive characteristic is not sufficient to prevent an end user from easily removing, by use of an average adult human's hands only, one of the crackers from the filling without breaking either of the crackers and without requiring that the cracker being removed be rotated with respect to the filling.

The aforementioned filling can comprise a cheese-based filling. This single-serving food item can be individually wrapped as a single-serving package. Supplemental food ingredients can accompany such a package. By one approach, one of the crackers can be easily removed from the cracker-and-filling sandwich to expose the filling and the supplemental food ingredient(s) placed thereon. The removed cracker can then be replaced to yield a nutritionally-supplemented cracker-and-filling sandwich.

Though cracker-and-filling sandwiches are known in the art, the cracker-and-filling sandwich described herein has numerous unique characteristics and properties. The ease by which the sandwich can be partially disassembled in at least some embodiments permits additional ingredients to be easily added. This permits a nutritional amplification that leverages the cracker-and-filling sandwich into a valid meal component. The size, shape, and constituent components of the cracker-and-filling sandwich, in turn, yield a single cracker-and-filling sandwich with the surprising ability to sate an ordinary between-meals appetite.

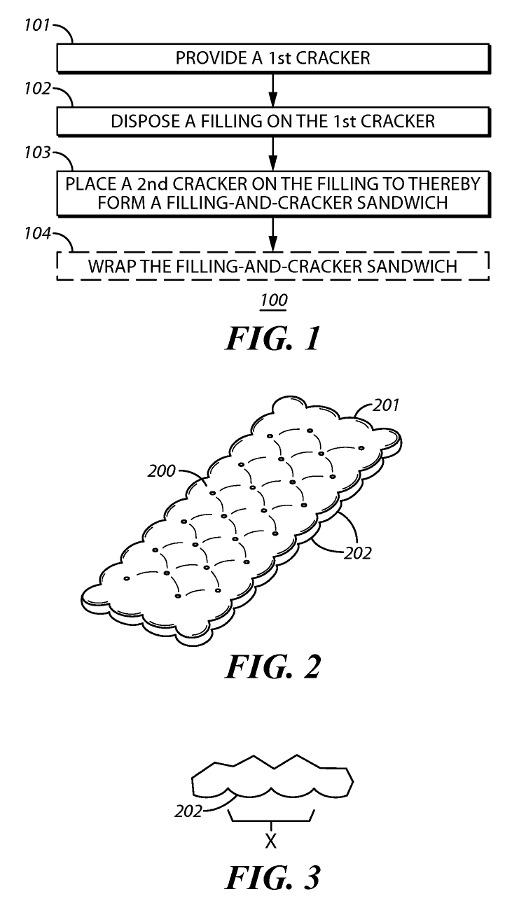

These and other benefits may become clearer upon making a thorough review and study of the following detailed description. Referring now to the drawings, and in particular to FIG. 1, an illustrative process 100 that is compatible with many of these teachings will now be presented.

Pursuant to step 101, this process 100 provides a first cracker. Those skilled in the art will understand a cracker to be a dry, thin, crispy, baked biscuit. As a non-limiting illustrative example in these regards, and referring momentarily to FIG. 2, this first cracker 200 can be relatively large (having a length, for example, of about 4.5 inches and a width of about 1 inch).

By one approach, and as illustrated, the periphery 201 of this first cracker 200 can comprise a plurality of scallops 202. Somewhat in accord with the relatively large size of the first cracker 200 itself, these scallops 202 are themselves rather large. As one illustrative example in these regards, and referring now momentarily to FIG. 3, there can be, on average, about two such scallops 202 per X where “X” is a distance ranging from, for example, about 0.5 to about 2 inches. In this particular illustrative example, and again without intending any particular limitations in these regards, X is about 1 inch.

This first cracker 200 can be formed using any of a variety of ingredients as will be well understood by those skilled in the art. By one approach, and in this illustrative example, this first cracker 200 will be at least substantially similar to the well-known Ritz brand cracker as baked and offered by Nabisco (albeit possibly somewhat thicker; here, this first cracker can have an average thickness of about one-eighth of an inch).

Referring again to FIG. 1, this process 100, at step 102, provides for disposing a filling on the first cracker 200. This filling can comprise a relatively viscous yet somewhat flowable material that will tend to retain its shape but which is also readily malleable. Though any number of ingredients can serve as a primary or secondary component of this filling, cheese is a particularly useful choice. Accordingly, for the purposes of illustration (but again without intending any limitations in these regards) this filling will be presented in this description as comprising a cheese-based filling.

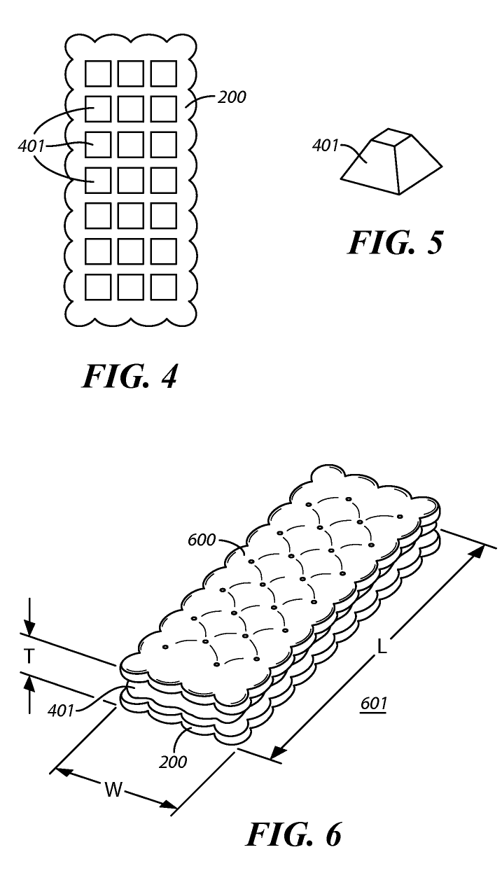

Referring momentarily to FIGS. 4 and 5, this filling 401 can be placed atop the first cracker 200 as a plurality of individual dollops. Each such dollop can have a wider base (where the filling 401 contacts the first cracker 200) than top or peak. As illustrated in FIG. 5, each such dollop comprises a kind of truncated pyramid. Those skilled in the art will recognize and understand that any number of other shapes are possible. It will also be understood that these teachings do not require that each dollop be identical to the other dollops in size, shape, footprint, height, or the like.

Generally speaking, the height of the dollops is somewhat higher than the expected thickness of this filling layer in the finally-constructed filling-and-cracker sandwich. As will be shown below, this will permit the filling 401 to be somewhat compressed in a latter step. With this in mind, the filling 401 can be sufficiently viscous that the resultant food product can be hand compressed by at least ten percent without coincidentally also breaking either of the crackers that form the sandwich.

By one approach, these dollops can be disposed on the first cracker 200 using three extrusion nozzles that are oriented laterally across the first cracker 200. As the first cracker 200 and these extrusion nozzles move with respect to one another, one row of dollops after another can be placed in seriatim manner. The amount of space left between such dollops (or whether there is any such space at all) will vary depending upon the needs and/or opportunities as tend to characterize a given application setting.

Those skilled in the art will recognize that each such dollop can be comprised of the same filling material. These teachings will also accommodate, however, other possibilities in these regards. For example, the outer dollops can be comprised of a filling that is based upon a first kind of cheese while the inner dollops are comprised of a filling that is based upon a second, different kind of cheese.

Referring again to FIG. 1, at step 103 this process 100 next provides for placing a second cracker on the aforementioned filling 401 to thereby form a filling-and-cracker sandwich. Such a resultant filling-and-cracker sandwich 601 appears in FIG. 6. In this illustrative example, this second cracker 600 is essentially identical to the first cracker 200. Those skilled in the art will recognize that this second cracker 600 could, however, be different from the first cracker 200 in any of a variety of ways. For example, this second cracker 600 could be formed of one or more different ingredients, a different mixture of the same ingredients, and/or could be formed to have a different shape or the like as desired.

In this illustrative example, where the second cracker 600 is essentially identical to the first cracker 200, the second cracker 600 is positioned to be in substantial vertical registration with the first cracker 200. Accordingly, the four corners of both crackers are in general vertical alignment with one another.

When so placing this second cracker 600 to form the filling-and-cracker sandwich 601, the second cracker 600 is urged downwardly with sufficient force to fully engage the filling 401 and to cause some corresponding compression of the filling 401. This compression can be sufficient to cause the filling 401 to fill the aforementioned spaces between the filling dollops and to also flow outwardly towards the periphery of the crackers. By one approach, there is neither so much filling 401, nor so much compression, as to cause the filling 401 to extend greatly beyond the periphery of the crackers for a substantial extent of that periphery.

In actual testing, when the filling 401 was compressed 3 mm at a rate of 1 mm/second, the filling flowed (which might be viewed by some skilled in the art as a kind of deformation) between the crackers in response to this relatively low pressure. More particularly, the corresponding pressure ranged from about 0.1 kg/square centimeter to about 0.3 kg/square centimeter (assuming the full cracker surface served as a contact area with the filling). Assuming that, in fact, only about seventy percent of the cracker surface served as a contact area, the relevant pressure range would be, instead, from about 0.15 kg/square centimeter to about 0.4 kg/square centimeter. (The differences between the low end and the high end of this range was generally attributable to different cheese powders that were used in different samples, with a cheddar cheese powder representing the low end of this range and a garlic herb cheese powder yielding the high end of this range.

In this particular illustrative example, the length-to-width ratio (L/W) can be at least 3:1 and is, as shown in excess of 4:1. Accordingly, the filling-and-cracker sandwich 601 is considerably longer than it is wide. Also in this example, the thickness of each cracker is about ⅛^{th} of an inch as is the resultant thickness of the filling 401 layer. This yields a resultant thickness of about ⅜ths of an inch for the filling-and-cracker sandwich 601. Generally speaking, by one approach, the length-to-width-to-thickness ratio (L/W/T) can be at least 3:1:0.25.

In consumer testing, such a filling-and-cracker sandwich 601 scored surprisingly high in numerous positive regards. For example, against a broad field of competing snack items such a filling-and-cracker sandwich 601 easily received a highest percentage of praise from the responding testers and little in the way of criticism. Although taste, mouthfeel, and the like no doubt play a part in such a favorable reception, it is the filling-and-cracker sandwich's satiety that may have also played a large part in garnering such a strong and broad-based favorable reaction.

In particular, in one blind monadic home-use test involving such a filling-and-cracker sandwich (involving hundreds of adult testers, both male and female in approximately equal numbers and with ages that reflect census age proportions and who all present themselves as typically snacking between meals), 88% agreed “completely or somewhat” with the statement “this product satisfies your hunger until your next meal.” More particularly, 51% of the test group agreed completely with that statement while only 6% disagreed somewhat or completely.

This measured effectiveness in sating between-meals appetite is even more surprising when one considers that the filling-and-cracker sandwiches being tested only offered between about 130 and 140 calories. At only 4.6 calories per gram, the confirmed satiety of the filling-and-cracker sandwich for such a large group of relevant testers constitutes a surprising result. As a potentially related observation, the filling-and-cracker sandwich used in these tests employed a cheese-based filing that included more fiber than the crackers themselves. More particularly, the filling comprised about 30% cheese powder with the remainder comprising fat, some solidification ingredients, and fiber (with about 3 grams of fiber being used for the filling in each filling-and-cracker sandwich). Fiber, of course, contributes to a good mouthfeel and lubricity, but may also have contributed to the unusual satiety of the tested filling-and-cracker sandwich.

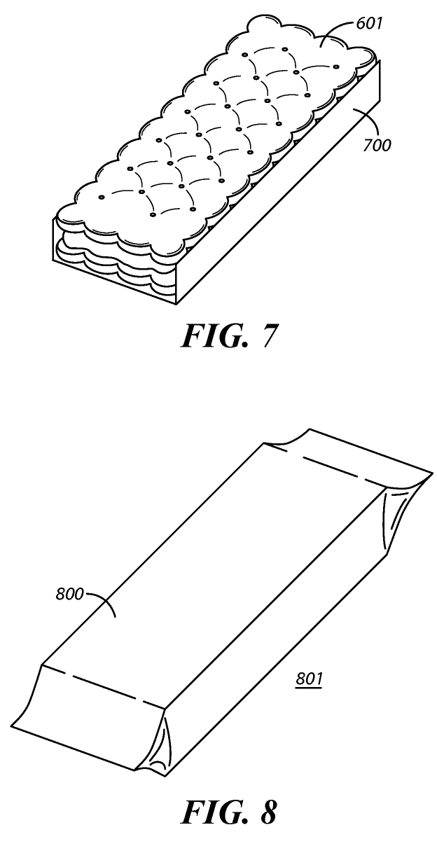

Given such telling results, and referring again to FIG. 1, these teachings will further optionally accommodate a step 104 of wrapping the filling-and-cracker sandwiches in individual wrappers as befits their clear status as single-serving snack items. By one approach, and referring now to FIG. 7, each filling-and-cracker sandwich 601 can be placed on a paperboard tray 700. If desired, and as illustrated, this paperboard tray 700 can have both a bottom and two sides to thereby provide considerable protection to the filling-and-cracker sandwich 601 from laterally and vertically-imposed forces.

Referring now to FIG. 8, the filling-and-cracker sandwich (with or without the aforementioned paperboard tray or other tray, container, or the like) can be placed within a wrapper 800 comprised of flexible material to thereby yield a corresponding single-serve package 801. Those skilled in the art will recognize that there are various known ways to wrap such a food product. By one approach, and as illustrated, the wrapper 800 can be applied using a flow-wrapper process as is well known in the art. Such a wrapper 800 will seal the filling-and-cracker sandwich away from local atmospheric influences and aid in preserving the freshness of the filling-and-cracker sandwich.

By one approach, if desired, the filling 401 can have an adhesive characteristic that is sufficient to retain the first and second crackers 200 and 600 in place during pre-sale handling, distribution, and sale of the food product. This adhesive characteristic can be sufficient to comprise a crumb-retention medium to thereby prevent most cracker crumbs from falling away from the filling-and-cracker sandwich 601 during consumption by an end user. The latter characteristic in particular befits the snacking-nature of the filling-and-cracker sandwich 601. In particular, the person consuming the filling-and-cracker sandwich 601 is likely eating the food product without the benefit of a plate or possibly even an official eating surface such as a dining table. Given this expected application setting, a reduction in resultant falling food-particle debris is most welcome by many consumers.

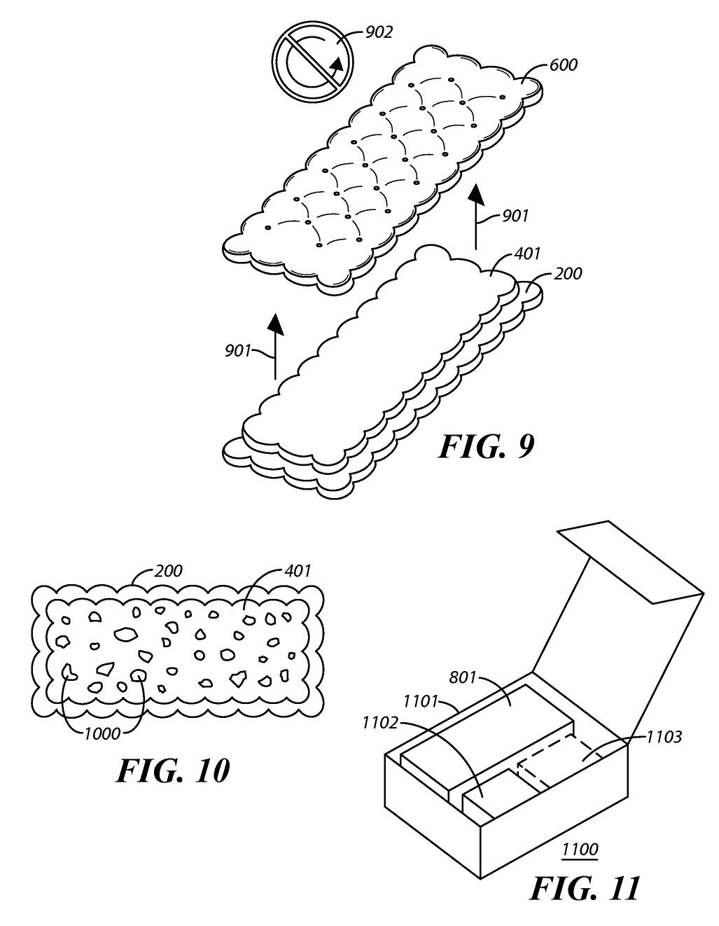

At the same time, however, this adhesive characteristic is not sufficient to prevent an end user from easily removing the second cracker 600 from the filling-and-cracker sandwich 601 using only their hands (presuming this end user to be an average able-bodied adult human with at least average dexterity and motor skills). As suggested by the illustration presented in FIG. 9, this removal of the second cracker 600 should be achievable without breaking either of the crackers 200 and 600. In testing, for example, only one cracker in thirty exhibited breakage when removing the second cracker 600 in this manner. Furthermore, this removal of the second cracker 600 should be achievable in this illustrative example by simply lifting the second cracker 600 away as indicated by the arrows denoted by reference numeral 901 and without requiring that the cracker being removed be rotated with respect to the filling (as represented by the icon denoted by reference numeral 902).

These teachings will accommodate some of the filling 401 becoming separated as well, such that a portion of the filling remains on the removed second cracker 600. Generally speaking, however, this separated portion will typically remain relatively small. For example, in many cases, less than 10% (or even less than 5%) of the total filling 401 will become separated and remain with the removed cracker. Referring now to actual test results in these regards filling-and-cracker sandwiches as described herein had the top cracker removed by lifting that top cracker without rotation. The weight of the filling remaining on that removed cracker was then compared against the total weight of the filling to determine the ratio of the removed filling to the original amount. Thirteen sandwiches (out of thirty) exhibited the removal of virtually no filling while four sandwiches exhibited the removal of only around 5% of the filling. Only in two cases (out of thirty) did 25% or more of the filling become separated.

It is believed that such a result can be achieved, at least in part, by the previously described approach of first disposing the filling 401 on the first cracker 200. Using this approach, a greater portion of the filling 401 will be in intimate adhesive contact with the first cracker 200 than with the second cracker 600. For example, by one approach, there may be twice as much filling surface area in intimate contact with the first cracker 200 than with the second cracker 600 as the first cracker 200 is in substantially greater surface-area contact with the filling 401 than the second cracker 600.

In any event, this ability to easily remove the top cracker from the filling-and-cracker sandwich offers other opportunities to leverage this food product design. As one illustrative example, and referring now to FIG. 10, after removing such a filling-and-cracker sandwich from its wrapper, and after removing one of the crackers as described, one can dispose at least one supplemental food item 1000 on the filling 401. The removed cracker can then be replaced in substantially unbroken form to thereby form a nutritionally-supplemented filling-and-cracker sandwich. Those skilled in the art will recognize that any number of supplemental food items will serve in these regards including, but not limited to, bacon bits, pepperoni slices or bits, flavored sauces, and so forth.

Referring now to FIG. 11, such a capability can be exploited by offering an individually wrapped filling-and-cracker sandwich 801 in a package 1101 that also includes such a supplemental food item 1102. Such a meal kit 1100 can optionally include one or more other items 1103 as desired (such as additional supplemental food items to add to the filling-and-cracker sandwich, side items to be individually consumed apart from the filling-and-cracker sandwich but during the same dining opportunity, utensils, and so forth).

For the sake of further explanation, but with no intention of suggesting any limitations in these regards, two specific salient examples regarding specific recipes for crackers and cheese-based fillings suitable for use in accord with these teachings will now be presented.

### EXAMPLE 1

To form the crackers, the following ingredients, in the following corresponding percentages (by weight), are mixed for 4 to 8 minutes in an upright mixer:

oil (2-20% though many application settings may benefit from observing a range of about 4-8%);

emulsifier (0-1%) (e.g., lecithin, mono- and di-glycerides, polyoxyethylene sorbitan fatty acid esters, DATEM (di-acetyl tartaric acid esters of mono- and diglycerides), stearoyl lactylates, and mixtures thereof);

sweetener (0-20% though many application settings may benefit from observing a range of about 0-8%) (e.g., sugars such as sucrose, fructose, glucose, high fructose corn syrup, or other sweet mono- or disaccharides commonly used in baking materials; all or a portion of the sugars may be augmented with artificial sweetener, nonnutritive sweetener, high intensity sweetener, sugar alcohol materials, and the like);

flour (50-75%, preferably 55-70%) (e.g., hard or soft wheat flours, red or white wheat flours, winter or spring, and blends thereof, whole wheat, all purpose flours, bleached or unbleached flours, or mixtures thereof may be used);

water (10-35% though many application settings may benefit from observing a range of about 10-25%).

The following ingredients are then added and the mixing continued for another 4 to 10 minutes:

leavening agent (0-5%), such as yeast, chemical leavening agent (e.g., ammonium bicarbonate, sodium bicarbonate, calcium bicarbonate, or a combination thereof), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone);

enzymes (0-3%);

flavor (0-1%); and

additional dough additives (0-15% though many application settings may benefit from observing a range of about 0-10%) (e.g., dough salt, herbs, seasonings, spices, the like, and mixtures thereof).

While the above recipe includes a two-step mixing process, a one-step mixing process may be used as long as the ingredients are well mixed prior to resting the dough. Also, if desired, the flour ingredients can be added other than as suggested above as regards the two-step mixing process.

The dough is then proofed (rested) (from about 30 minutes to about 240 minutes), sheeted, and laminated. A cutter can serve to unitize individual crackers having the desired shape, size, and weight. Topping salt can also be added at this time. The length of time and temperature selected for baking will generally depend on the type of oven available. Generally, the dough can be baked in a conventional oven at a temperature of about 250-550° F. for 3 to 8 minutes to provide the desired bake profile, although other temperatures and bake times may also be used so long as the desired bake profile is provided.

Following the baking process, it is preferable, but not required, to apply oil to one or both sides of the crackers to provide additional moisture, color, and savory flavor to the cracker.

### EXAMPLE 2

To form the filling, the following ingredients, in the following corresponding percentages (by weight), are mixed for about 1 to 2 minutes in a high shear mixer:

fat (20-60%, preferably 30-45%) (e.g., vegetable oils, shortening, hydrogenated oil, and the like); and

emulsifier (0-2%) (e.g., lecithin, mono- and di-glycerides, polyoxyethylene sorbitan fatty acid esters, DATEM (di-acetyl tartaric acid esters of mono- and diglycerides), stearoyl lactylates, and combinations thereof);

The following ingredients are then added and mixing continues for another 6 to 15 minutes:

bulking agent (10-50%) (e.g., corn syrup solids, fiber, inulin, maltodextrin, thickeners, resistant maltodextrin, lactose, and combinations thereof, although a combination of 10-20% resistant maltodextrin, 5-15% maltodextrin, and 5-15% corn syrup solids is particularly preferred);

cheese powder (20-45%, preferably 25-35%); and flavors (0-2%).

Again, while the above recipe includes a two-step mixing process, a one-step mixing process may be used as long as the ingredients are mixed to provide a substantially homogeneous mixture. It would also be possible to introduce some of these ingredients in a step other than the one shown.

These teachings yield a single-serving-sized filling-and-cracker sandwich that is remarkably successful at sating between-meals appetites when used as a snack food. Its form factor and single-serving-sized packaging is both suggestive of this purpose and also effective to suggest to the consumer that consuming further such filling-and-cracker sandwiches is unnecessary. Furthermore, such a filling-and-cracker sandwich is readily leveragable as a key component in a meal kit as the filling-and-cracker sandwich is easily opened in order to permit an end user to supplement the filling-and-cracker sandwich with additional ingredients.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A food product, comprising:
a first cracker having a length of at least three inches;
a second cracker having a length of at least three inches;
a non-cracker filling disposed between the first and second crackers to form a corresponding cracker-and-filling sandwich.

2. The food product of claim 1 further comprising:
a wrapper disposed and sealed about the cracker-and-filling sandwich to thereby individually encapsulate the cracker-and-filling sandwich as a single serving.

3. The food product of claim 2 wherein the wrapper comprises a flow wrapper.

4. The food product of claim 1 wherein the cracker-and-filling sandwich has a length-to-width ratio of at least 3:1.

5. The food product of claim 4 wherein the cracker-and-filling sandwich has a length of at least four inches.

6. The food product of claim 1 wherein the cracker-and-filling sandwich has a length-to-width-to-thickness ratio of at least 3:1:0.25.

7. The food product of claim 1 wherein each of the first and second cracker have a scalloped periphery.

8. The food product of claim 7 wherein the scalloped periphery comprises a plurality of scallops that are substantially uniform in shape and dimension and wherein there are no more than about two scallops per linear inch.

9. The food product of claim 1 wherein the filling comprises a cheese-based filling.

10. A food product comprising a cracker-and-filling sandwich, wherein the cracker-and-filling sandwich is sized and comprised of ingredients such that eating the cracker-and-filling sandwich as a between-meal snack satisfactorily sates an average adult human being's appetite pending a next normally-scheduled meal.

11. The food product of claim 10 wherein the cracker-and-filling sandwich is individually wrapped as a single-serving package.

12. The food product of claim 11 further comprising:
a paperboard tray disposed within the package to protect the cracker-and-filling sandwich from breakage.

13. The food product of claim 10 wherein the cracker-and-filling sandwich has a calories-per-gram ratio of no more than about 5 calories/gram.

14. The food product of claim 10 wherein fiber content of the cracker-and-filling sandwich is owing more to the filling than to cracker content.

15. A food, product comprising:
a sealed individual-serving wrapper;
a cracker-and-filling sandwich disposed within the wrapper;
wherein the filling has an adhesive characteristic sufficient to retain first and second crackers in place during pre-sale handling, distribution, and sale of the food product, but wherein the adhesive characteristic is not sufficient to prevent an end user from easily removing, by use of an average adult human's hands only, one of the first and second crackers from the filling without breaking either of the crackers and without requiring that the cracker being removed be rotated with respect to the filling.

16. The food product of claim 15 wherein the adhesive characteristics are sufficient to comprise a crumb-retention medium to thereby prevent most cracker crumbs from falling away from the food product during consumption by an end user.

17. The food product of claim 15 wherein the filling is sufficiently viscous that the food product can be hand compressed by at least ten percent without coincidentally breaking either of the crackers.

18. The food product of claim 15 wherein the filling will deform and flow between the first and the second crackers when vertically compressed 3 millimeters at a rate of 1 millimeter per second with a pressure ranging from no less than about 0.1 kilogram per square centimeter to no more than about 0.4 kilogram per square centimeter.

19. The food product of claim 15 wherein the filling comprises a cheese-based filling.

20. The food product of claim 15 further comprising:
a package that contains the cracker-and-filling sandwich as wrapped within the wrapper;
at least one supplemental food item that is also disposed within the package;
such that an end user can easily remove a cracker from the cracker-and-filling sandwich, dispose the at least one supplemental food item on the filling, and replace the cracker in substantial unbroken form to thereby form a nutritionally-supplemented cracker-and-filling sandwich.

21. The food product of claim 15 wherein the first cracker is in substantially greater surface-area contact with the filling than the second cracker.
